(19) United States
(12) Patent Application Publication
(10) Pub. No.: US 2008/0159204 A1
(43) Pub. Date: Jul. 3, 2008

(54) Techniques for lossless packet transition across basic service sets in wireless networks

(76) Inventors: Emily H. Qi, Portland, OR (US); Max Fudim, Newton, MA (US); Christian Maciocco, Portland, OR (US); Myron Hattig, Portland, OR (US); Boris Ginzburg, Haifa (IL)

Correspondence Address: INTEL CORPORATION;c/o INTELLEVATE, LLC, P.O. BOX 52050, MINNEAPOLIS, MN, 55402, US

(21) Appl. No.: 11/648,338

(22) Filed: Dec. 28, 2006

(51) Int. Cl. H04Q 7/00; H04M 1/00

(52) U.S. Cl. 370/328; 455/550.1

(57) ABSTRACT

An embodiment of the present invention provides a system, comprising a wireless station (STA), a first access point (AP1) operable to communicate with the wireless station, a second access point (AP2) operable to communicate with the wireless station, and wherein the STA is adapted to transition wireless communications from the first access point (AP1) to the second access point (AP2) using a Post-Transition Extended Session and a Post-Transition Extended Session Aliveness Interval to allow the STA and AP1 to keep an old session alive for the duration of the Post-Transition Extended Session Aliveness Interval and during the Post-transition Extended Session, the STA can come back to the AP1 and recover all the leftover packets.

### BACKGROUND

Packet loss is a well-known issue when a mobile client transitions from one Access Point (AP) to another AP. With the Institute for Electronic and Electrical Engineers (IEEE) 802.11r (Fast BSS Transition) standard under development, the transition time between two APs has been reduced significantly, but there is still a window of time, while the 802.11r signaling finishes up its last phase, where packets will still be directed to the old AP and thus be lost. Packet losses are mainly caused by queued packets in the old AP awaiting transmission once the client has moved to the new AP, and misdirected packets (to the old AP) during the transition processes. The introduction of the Aggregated MSDU in IEEE 802.11n device significantly worsens the situation that is described above.

Thus, a strong need exists for techniques for lossless packet transition across basic service sets in wireless networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the packet loss during the BSS transition of an embodiment of the present invention; and

FIG. 2 is a procedure of packet loss avoidance transition of an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a network, a wireless network, a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like. Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), ZigBee (TM), or the like. Embodiments of the invention may be used in various other apparatuses, devices, systems and/or networks.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

As stated above, packet loss is a key issue when a mobile client transitions from one AP to another AP. With the IEEE 802.11r (Fast BSS Transition) techniques, the transition time between AP has been significantly reduced, but there is still a window of time where packets may be lost. Especially, those packets queued in the current AP during the transition phase or misdirected to the old AP during this same transition period will be lost. This will become worse with 802.11n A-MSDU capability, increasing the losses during the transition.

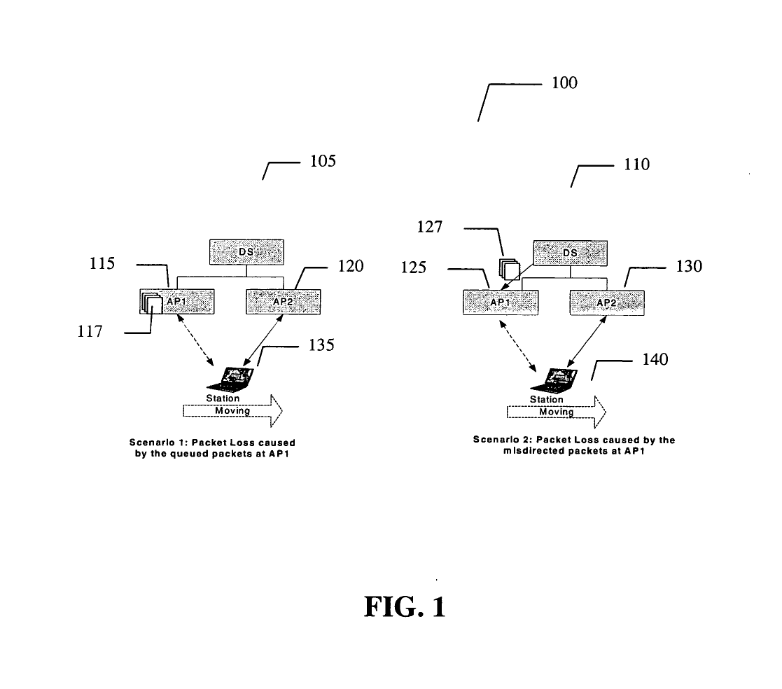

As seen in FIG. 1, Packet Loss may occur during the BSS transition. In scenario 1 at 105 DS connects AP1 and AP2 which may wirelessly communicate with wireless station (STA) 135 and in this scenario packet loss is caused by the queued packets 117 at AP1 115. In scenario 2 at 110, again DS connects AP1 125 and AP2 130 with STA 140 and packet loss may be caused by the misdirected packets 127 at AP1 140.

An embodiment of the present invention provides a network/AP assisted scheme to allow STA to receive the queued packets from the old AP after the STA re-associates to the new AP. The proposed scheme results in zero packet loss during BSS transition. This packet loss 20 avoidance scheme enables seamless connectivity of VoIP, Video conferencing, and Video stream during BSS transition. An embodiment of the present invention may be easily deployed in Communication Platforms, handheld devices, or access points to improve wireless product performance and enable a richer wireless LAN experience for mobile users.

An embodiment of the present invention enables seamless and lossless transition among APs and may be particularly important for incoming type of devices like Ultra-Mobile PC (UMPC), handheld devices, etc. as it provides the following:

1. It defines a Post-Transition Session Aliveness Interval to extend AP and STA's association session aliveness and session key aliveness after STA reassociates to a new AP.

2. It avoids creating two association sessions which may cause confusion for packet forwarding. The old session is only considered as an extension session between the old AP and the STA. At the network switch or AP controller side, only the new association session is recorded.

3. It defines a negotiation scheme to allow AP and STA to sync-up Post-Transition Session aliveness, and aliveness interval.

4. It defines a sequence of transition operations which create lossless packet transition by using the existing Power Saving mode operation.

Some embodiments of the present technology provide a Post-Transition Extended Session and a Post-Transition Extended Session Aliveness Interval (PostTransitionSessionAlivenessInterval). After the station (STA) transitioned to the new AP, STA and old AP shall keep the old session alive, Pairwise Temporal Key (PTK) and Group Temporal Key (GTK) alive for the duration of the Post-Transition Extended Session Aliveness Interval. During the Post-transition Extended Session, the STA may come back to the old AP and recover all the leftover packets. The Post-Transition Session Aliveness Interval may be 2 bytes long, and may be negotiated between AP and STA during (re)association process. The value of 0 indicates that AP and STA don't support this feature.

Some embodiments of the present invention provide for following procedures for the packet loss avoidance transition operation:

Assume the STA is associated to AP1. When the STA decides to roam to a new AP (e.g. AP2), the STA will send Power Saving Mode indication to AP1, so AP1 will buffer any incoming data for the STA.

The STA will conduct Reassociation process and key derivation with the new AP (AP2), i.e. the 802.11r incoming standard procedures.

When the STA receives the Reassociation response from AP2, the STA immediately sends a Power saving mode indication to the new AP (AP2). So AP2 will buffer any incoming data for the STA.

The STA switches to the old AP (AP1) and checks whether there is any data buffered. If yes, the STA will poll the buffered data from AP1.

Once the STA cleans up the data, the STA will switch to the new AP and indicate its “active”, and poll the buffered packet from the new AP.

AP1 can now clean up the association state or based on time-out let the state expire.

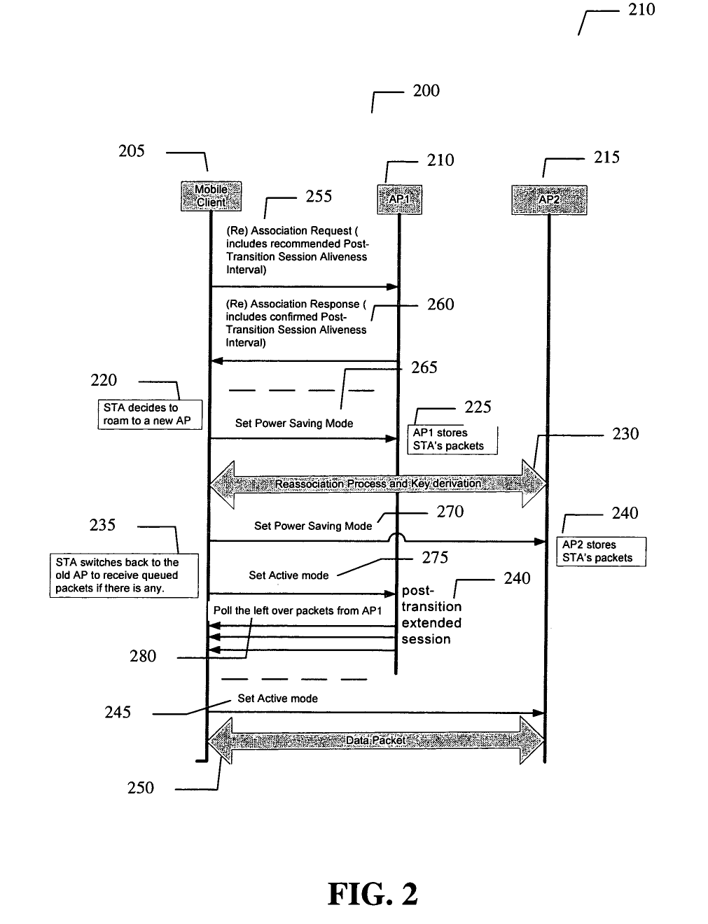

Turning now to FIG. 2, shown generally as 200, is a procedure of packet loss avoidance transition of an embodiment of the present invention. Mobile client 205 may send a (re) Association Request which may include recommended Post Transition Session Aliveness Interval 255 to AP1 210. AP1 210 may respond with a (Re)association Response which may include confirmed Post-Transition Session Aliveness Interval 260. When STA decides to roam to a new AP at 220 it may send instructions at 265 to set power saving mode. AP1 stores STA's packets at 225 in response to instructions at 265 to set power saving mode. 230 depicts the reassociation Process and Key derivation communication between mobile client 25 and AP2 215. At 270 Mobile Client 205 sends power saving mode instructions to AP2. The STA switches back to the old AP to receive queued packets if there are any at 235 and sets active mode instructions to AP1 at 275. At 240 the post-transition extended session occurs and AP1 polls the left over packets at 280. 245 indicates the active mode is set by Mobile Client 205 to AP2.

Some embodiments of the present invention may be implemented, for example, using a machine-readable medium or article which may store an instruction or a set of instructions that, if executed by a machine, for example, by the apparatus and system of FIG. 2, by mobile client or wireless station (STA) 205, in communication with AP1 210 and AP2 215, by a processor (not shown), or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

In an embodiment of the present invention, the machine-accessible medium that provides instructions, which when accessed, may cause the machine to perform operations comprising using a Post-Transition Extended Session and a Post-Transition Extended Session Aliveness Interval by wireless station (STA) to transition wireless communications from a first access point (AP1) to a second access point (AP2). In an embodiment of the present invention the machine-accessible medium may further comprise the instructions causing the machine to perform operations further comprising allowing the STA and AP1 to keep an old session alive for the duration of the Post-Transition Extended Session Aliveness Interval and during the Post-transition Extended Session and coming back to the AP1 and recovering all the leftover packets by the STA; the instructions may cause the machine to perform operations further comprising, causing the Post-Transition Session Aliveness Interval to be 2 bytes long.

Further, in an embodiment of the present invention, the machine-accessible medium may further comprise the instructions causing the machine to perform operations further comprising sending a Power Saving Mode indication to AP1 when the STA decides to roam to AP2 so AP1 will buffer any incoming data for the STA and whereafter the STA will conduct Reassociation process and key derivation with AP2, and also may comprise the instructions causing the machine to perform operations further comprising when the STA receives a Reassociation response from AP2, causing the STA to immediately send a Power saving mode indication to AP2 so AP2 will buffer any incoming data for the STA and causing the STA to switch to AP1 and to check whether there is any data buffered and, if yes, causing the STA to poll the buffered data from AP1.

Also, in an embodiment of the present invention the machine-accessible medium may further comprise the instructions causing the machine to perform operations further comprising switching to the new AP and indicating its “active” and polling the buffered packet from AP2 once the STA cleans up the data, and subsequently cleaning up the association state by AP1 or, based on time-out, letting the state expire.

Some embodiments of the present invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Yet another embodiment of the present invention provides a system, comprising a wireless station (STA); a first access point (AP1) operable to communicate with the wireless station; a second access point (AP2) operable to communicate with the wireless station; and

wherein the STA is adapted to transition wireless communications from the first access point (AP1) to the second access point (AP2) using a Post-Transition Extended Session and a Post-Transition Extended Session Aliveness Interval to allow the STA and AP1 to keep an old session alive for the duration of the Post-Transition Extended Session Aliveness Interval and during the Post-transition Extended Session, the STA can come back to the AP1 and recover all the leftover packets.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. An apparatus, comprising:
a wireless station (STA) operable to transition wireless communications from a first access point (AP1) to a second access point (AP2); and
wherein said wireless handset during said wireless communications transition uses a Post-Transition Extended Session and a Post-Transition Extended Session Aliveness Interval.

2. The apparatus of claim 1, wherein said Post-Transition Extended Session and said Post-Transition Extended Session Aliveness Interval allow said STA and AP1 to keep an old session alive for the duration of the Post-Transition Extended Session Aliveness Interval and during the Post-transition Extended Session, said STA can come back to the AP1 and recover all the leftover packets.

3. The apparatus of claim 2, wherein said Post-Transition Session Aliveness Interval is 2 bytes long, and is negotiated between AP1 and STA during an association or reassociation process.

4. The apparatus of claim 3, wherein when said STA decides to roam to AP2, said STA sends a Power Saving Mode indication to AP1, so AP1 will buffer any incoming data for the STA, whereafter said STA will conduct Reassociation process and key derivation with AP2.

5. The apparatus of claim 4, wherein when said STA receives a Reassociation response from AP2, said STA immediately sends a Power saving mode indication to AP2 so AP2 will buffer any incoming data for the STA and said STA switches to AP1 and checks whether there is any data buffered and, if yes, said STA will poll the buffered data from AP1.

6. The apparatus of claim 5, wherein once said STA cleans up the data, the STA will switch to the new AP and indicate its “active”, and poll the buffered packet from AP2 and subsequently AP1 cleans up the association state or, based on time-out, let the state expire.

7. A method, comprising:
using a Post-Transition Extended Session and a Post-Transition Extended Session Aliveness Interval by wireless station (STA) to transition wireless communications from a first access point (AP1) to a second access point (AP2).

8. The method of claim 7, further comprising allowing said STA and AP1 to keep an old session alive for the duration of the Post-Transition Extended Session Aliveness Interval and during the Post-transition Extended Session and coming back to the AP1 and recovering all the leftover packets by said STA.

9. The method of claim 8, wherein said Post-Transition Session Aliveness Interval is 2 bytes long, and is negotiated between AP1 and STA during an association or reassociation process.

10. The method of claim 9, further comprising sending a Power Saving Mode indication to AP1 when said STA decides to roam to AP2 so AP1 will buffer any incoming data for the STA and whereafter said STA will conduct Reassociation process and key derivation with AP2.

11. The method of claim 10, wherein when said STA receives a Reassociation response from AP2, said STA immediately sends a Power saving mode indication to AP2 so AP2 will buffer any incoming data for the STA and said STA switches to AP1 and checks whether there is any data buffered and, if yes, said STA will poll the buffered data from AP1.

12. The method of claim 11, further comprising switching to the new AP and indicating its “active” and polling the buffered packet from AP2 once said STA cleans up the data, and subsequently cleaning up the association state by AP1 or, based on time-out, letting the state expire.

13. A machine-accessible medium that provides instructions, which when accessed, cause a machine to perform operations comprising:
using a Post-Transition Extended Session and a Post-Transition Extended Session Aliveness Interval by wireless station (STA) to transition wireless communications from a first access point (AP1) to a second access point (AP2).

14. The machine-accessible medium of claim 13, further comprising said instructions causing said machine to perform operations further comprising allowing said STA and AP1 to keep an old session alive for the duration of the Post-Transition Extended Session Aliveness Interval and during the Post-transition Extended Session and coming back to the AP1 and recovering all the leftover packets by said STA.

15. The machine-accessible medium of claim 14, further comprising said instructions causing said machine to perform operations further comprising, causing said Post-Transition Session Aliveness Interval to be 2 bytes long.

16. The machine-accessible medium of claim 15, further comprising said instructions causing said machine to perform operations further comprising sending a Power Saving Mode indication to AP1 when said STA decides to roam to AP2 so AP1 will buffer any incoming data for the STA and whereafter said STA will conduct Reassociation process and key derivation with AP2.

17. The machine-accessible medium of claim 16, further comprising said instructions causing said machine to perform operations further comprising when said STA receives a Reassociation response from AP2, causing said STA to immediately send a Power saving mode indication to AP2 so AP2 will buffer any incoming data for the STA and causing said STA to switch to AP1 and to check whether there is any data buffered and, if yes, causing said STA to poll the buffered data from AP1.

18. The machine-accessible medium of claim 17, further comprising said instructions causing said machine to perform operations further comprising switching to the new AP and indicating its “active” and polling the buffered packet from AP2 once said STA cleans up the data, and subsequently cleaning up the association state by AP1 or, based on time-out, letting the state expire.

19. A system, comprising:
a wireless station (STA);
a first access point (AP1) operable to communicate with said wireless station;
a second access point (AP2) operable to communicate with said wireless station; and
wherein said STA is adapted to transition wireless communications from said first access point (AP1) to said second access point (AP2) using a Post-Transition Extended Session and a Post-Transition Extended Session Aliveness Interval to allow said STA and AP1 to keep an old session alive for the duration of the Post-Transition Extended Session Aliveness Interval and during the Post-transition Extended Session, said STA can come back to the AP1 and recover all the leftover packets.

20. The system of claim 19, wherein said Post-Transition Session Aliveness Interval is 2 bytes long, and is negotiated between AP1 and STA during an association or reassociation process.

21. The system of claim 20, wherein when said STA decides to roam to AP2, said STA sends a Power Saving Mode indication to AP1, so AP1 will buffer any incoming data for the STA, whereafter said STA will conduct Reassociation process and key derivation with AP2.

22. The system of claim 21, further comprising a di-pole directional antenna connected to said AP1 and/or AP2.
